(19) United States
(12) Patent Application Publication
(10) Pub. No.: US 2016/0203928 A1
(43) Pub. Date: Jul. 14, 2016

(54) Magnetic deadman switch

(71) Applicant: David Michael Mervine, Austin, TX (US)

(72) Inventor: David Michael Mervine, Austin, TX (US)

(21) Appl. No.: 14/757,810

(22) Filed: Dec. 22, 2015

Related U.S. Application Data
(60) Provisional application No. 62/124,478, filed on Dec. 22, 2014.

(51) Int. Cl. H01H 36/02

(52) U.S. Cl. CPC H01H 36/02; H01H 2300/026

(57) ABSTRACT

Various implementations of a magnetic deadman switch are provided. In one implementation, for example, the switch comprises a housing and a pair of electrical connectors coupled to the housing. A magnet component is adapted to move between a first closed position and a second open position. The magnet component is adapted to be magnetically drawn toward the pair of electrical connectors and electrically couple the pair of connectors in the first closed position. The magnet component is also adapted to be magnetically drawn away from the pair of electrical connectors and electrically open the pair of electrical connectors in the second open position.

### CROSS-REFERENCE TO RELATED APPLICATIONS

This application claims the benefit of U.S. provisional application No. 62/124,478, filed 22 Dec. 2014, which is hereby incorporated by reference as though fully set forth herein.

### BACKGROUND

a. Field

The instant invention relates to magnetic electrical switches.

b. Background

Battery life is one of the key aspects of modern electronic devices. Many of these devices use an electronic switch, such as a transistor, to turn on and off. The electronic switch, however, consumes a small amount of energy even when it is turned off. This is commonly referred to as leakage current, in the case of a transistor.

A typical mechanical switch consumes no energy in the off or open switch position. This means the lifetime of a battery is the same as the battery's shelf life, assuming the device always remains off. The amount of time the device is switched on or powered up reduces the battery lifetime, based on the amount of energy the device uses while turned on.

### BRIEF SUMMARY

A magnetic deadman switch is provided in which a mechanical switch is closed by a magnet to activate or turn on the switch. While the switch is open or turned off, the switch enables the electronic device to extend the battery life to a maximum level afforded by a given battery, as it behaves equivalently to a mechanical switch. The switch comprises a deadman switch because its natural state is closed; it is held open by a magnet.

In one implementation, for example, the deadman switch is incorporated into a wearable item, such as a wristband. In a first ON state, a magnet of the deadman switch electrically couples a pair of opposing wires and/or contacts allowing the switch to conduct between the pair of opposing wires and/or contacts. In a second OFF state, a second component of the deadman switch attracts the magnet away from the pair of opposing wires and/or contacts opening the circuit and preventing current from flowing between the pair of opposing wires and/or contacts.

A magnetic deadman switch is provided. In one implementation, for example, the switch comprises a housing and a pair of electrical connectors coupled to the housing. A magnet component is adapted to move between a first closed position and a second open position. The magnet component is adapted to be magnetically drawn toward the pair of electrical connectors and electrically couple the pair of connectors in the first closed position. The magnet component is also adapted to be magnetically drawn away from the pair of electrical connectors and electrically open the pair of electrical connectors in the second open position.

In one implementation, for example, the housing comprises an opening and the magnet component is disposed within the opening of the housing. In another example, implementation, the housing comprises a post and the magnet component is disposed on the post.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows a schematic partial cross section view of an example implementation of a magnetic deadman switch in a first closed ON state.

FIG. 2 shows a schematic partial cross section view of the example implementation of the magnetic deadman switch of FIG. 1 in a second open OFF state.

FIG. 3 shows a schematic partial cross section view of another example implementation of a magnetic deadman switch in a first closed ON state.

FIG. 4 shows a schematic partial cross section view of the example implementation of the magnetic deadman switch of FIG. 3 in a second open OFF state.

FIG. 5 shows a schematic partial cross section view of yet another example implementation of a magnetic deadman switch in a first closed ON state.

FIG. 6 shows a schematic partial cross section view of the example implementation of the magnetic deadman switch of FIG. 5 in a second open OFF state.

FIG. 7 shows a schematic partial cross section view of an example implementation of an example magnetic deadman switch coupled between an example voltage source and an application circuit.

FIG. 8 shows a schematic partial cross section view of an example implementation of an example magnetic deadman switch coupled between an example voltage source and an application circuit comprising a light emitting diode indicator.

FIG. 9 shows a schematic partial cross section view of another example implementation of an example magnetic deadman switch coupled between an example voltage source and an application circuit comprising a microcontroller and transmitter.

FIG. 10 shows a schematic plan view of an example implementation of a housing including a pair of opposing wires forming a pair of electrical connectors that may be used with various implementations of a deadman switch.

### DETAILED DESCRIPTION

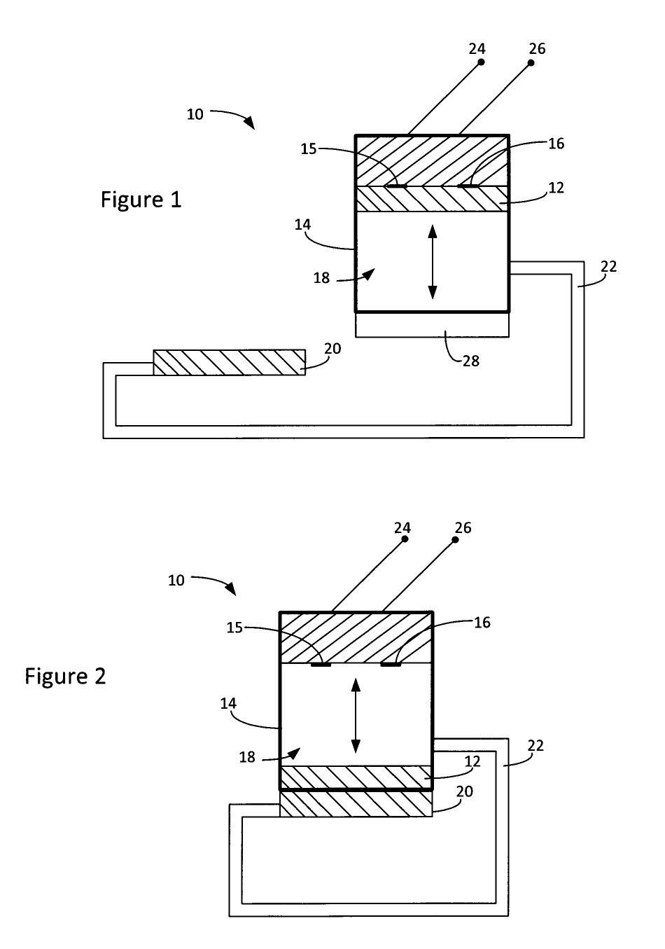

FIGS. 1 and 2 show a schematic partial cross section view of an example implementation of a switch 10 that includes a first magnet component 12 disposed within a housing 14 of the switch 10. FIG. 1 shows the switch 10 in a first closed ON state, and FIG. 2 shows the switch 10 in a second open OFF state. In this implementation, the first magnet component 12 comprises an at least partially conductive magnet that is adapted to electrically couple a pair of opposing wires and/or contacts 15, 16 of the switch 10 to close the switch in a first ON state. The first magnet component 12, for example, may include a magnet that includes a conductive coating (e.g., a neodymium magnet) film, or other layer that, in some implementations, may further operate to prevent the magnet from corroding. The first magnet component 12 may also be attached to one or more conductive features that are adapted to electrically couple the pair of opposing wires and/or contacts 15, 16 when the first magnet component 12 is drawn into contact with the pair of opposing wires and/or contacts 15, 16.

In this implementation, for example, the first magnet component 12 is disposed within an opening 18 of the switch housing/body 14. The first magnet component 12 is moveable within the opening of the housing such that in a first ON state, the magnet electrically couples a pair of opposing wires and/or contacts 15, 16 of the switch 10. The first ON state of the switch 10 comprises a normal or default state in which the first magnet component 12 is magnetically drawn to a material of the pair of opposing wires and/or contacts 15, 16. In a second OFF state of the switch 10, a second component 20 of the switch, such as but not limited to a second magnet, paramagnetic or metal (e.g., ferrous metal) component, may also be magnetically drawn to the first magnet component 12 disposed within the housing 14. In this implementation, in the absence of the second component 20 being disposed adjacent to the housing 14, the first magnet component 12 disposed within the housing 14 is magnetically drawn to the pair of opposing wires and/or contacts 15, 16 and closes the switch 10 in an ON state. When the second component 20 is disposed adjacent to the housing, such as shown in FIG. 2, however, the magnetic attraction between the first magnet component 12 disposed within the opening 18 of the housing 14 to the pair of opposing wires and/or contacts 15, 16 is overcome by a magnetic attraction between the first magnet component 12 disposed within the housing 14 and the second component 20 disposed adjacent to the housing 14. In this manner, the first magnet component 12 is drawn toward the second component 20 and away from the pair of opposing wires and/or contacts 15, 16 and opens the contacts of the switch 10 resulting in the second OFF state.

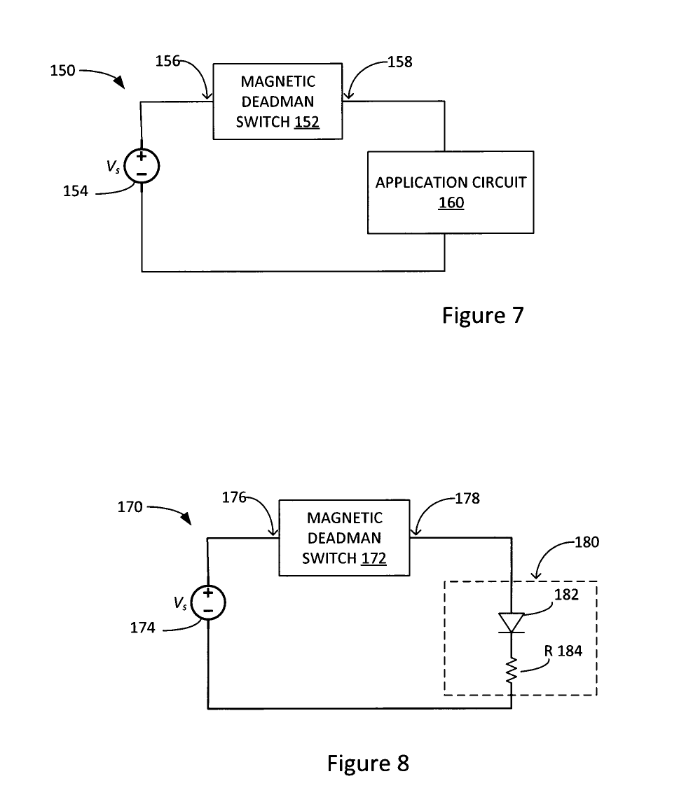

In the particular implementation shown in FIGS. 1 and 2, for example, the second component 20 is coupled to the switch housing 14, such as via a strap, lead, band or other coupling device 22. In this manner, the second component 20 may be moved to or from the position adjacent to the housing (shown in FIG. 1) to transition the switch between the first closed ON state and the second open OFF state while still being physically coupled to the switch housing so that the second component is not lost or misplaced. In one particular implementation, for example, the switch 10 may comprise a clasp for a wearable item, such as a jewelry clasp for a wristband that may be worn by a person. In this manner, as the item is worn by the person, the clasp is engaged and held in place by a magnetic attraction between the first magnet component 12 and the second component 20 such that the switch is maintained in a second open OFF state and current from a battery coupled to the switch is prevented from flowing through the switch into an application circuit. However, when the second component 20 is physically moved away from the housing 14 (such as shown in FIG. 2), the magnetic attraction between the first magnet component 12 and the pair of opposing wires and/or contacts 15, 16 draws the first magnet component 12 within the opening of the housing 14 to a position adjacent to the pair of opposing wires and/or contacts 24, 26 and electrically couples the pair of opposing wires and/or contacts 15, 16 and transitions the switch to a first closed ON state. In the first closed ON state, the switch 10 allows current to flow from a power source (e.g., a battery) coupled to the switch 10 to an application circuit, such as shown in FIGS. 7-9, via switch terminals 24, 26 and activates the application circuit.

In the particular implementation shown in FIGS. 1 and 2, the housing 14 further comprises a backing/support member 28 that extends from the housing 14 and provides an alignment device for aligning and positioning the second component 20 adjacent to the housing in a predetermined location relative to the first magnet component 12, such as shown in FIG. 2. In one example, the backing/support member may extend around all or a portion of an outer perimeter of the housing 14. The backing/support member 28, for example, may extend from multiple sides of a generally polygon shaped housing, along an arc of a generally cylindrical shaped housing or from any other shaped housing. The backing/support member 28 may be molded, machined or otherwise formed with one or more component of the housing 14 or may be attached or affixed to the housing using any conventional means. In some implementations, for example, the backing support member may comprise a member extending from one or more sidewall of the housing 14 or may form a pocket, slot, sleeve or other configuration to receive and hold the second component 20 in a position relative to the housing 14 and first magnet component 12.

The housing 14 may comprise any shape or structure. The opening 18 of the housing 14 may be sealed or open. Further, the housing and opening therein may be any shape or structure, such as but not limited to a cylinder, a rectangular prism, a triangular prism, a cube, a sphere, a cone, a triangular or rectangular pyramid, or the like. In one particular implementation, for example, the housing 14 may comprise a cylindrical shape with a corresponding opening. In this particular example, the housing may further comprise a lip or stop structure on an open end that retains a generally round (e.g., disc, annular, cylindrical or other shape) first magnetic component within the opening of the housing.

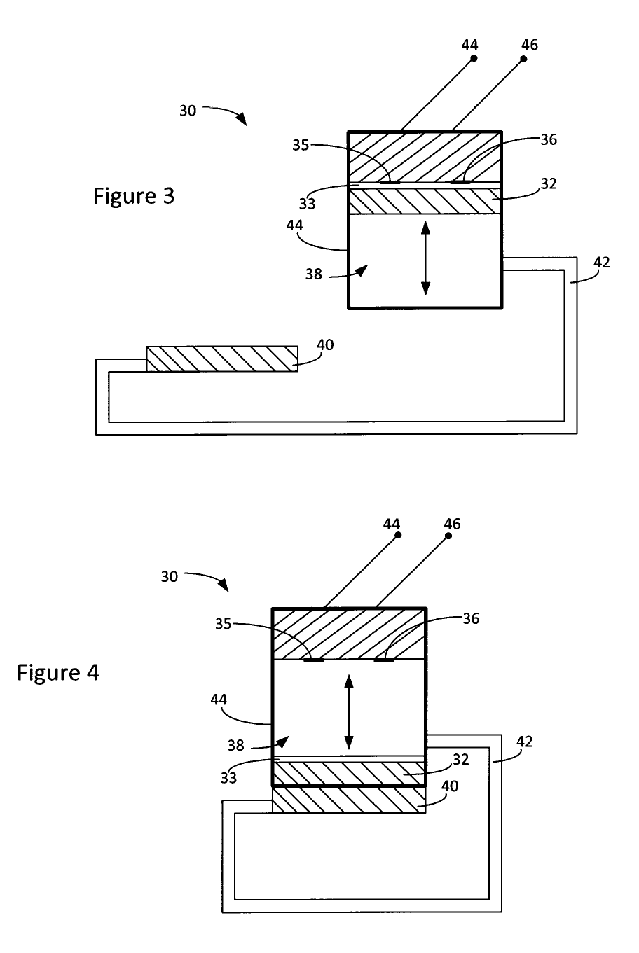

FIGS. 3 and 4 show a schematic partial cross section view of another example implementation of a magnetic deadman switch 30. FIG. 3 shows the example magnetic deadman switch 30 in a first closed ON state, and FIG. 4 shows the example magnetic deadman switch 30 in a second open OFF state. In this implementation, the first magnet component 32 comprises a magnet that is adapted to move and an at least partially conductive contactor 33 disposed adjacent to and adapted to electrically couple a pair of opposing wires and/or contacts 35, 36 of the switch 30 to close the switch in a first ON state. The first magnet component 32, for example, may be attached to the at least partially conductive contactor 33 that is adapted to electrically couple the pair of opposing wires and/or contacts 35, 36 when a magnetic attraction between the first magnet component 32 and the pair of opposing wires and/or contacts 35, 36 draws the first magnet component 32 and the at least partially conductive contactor 33 adjacent to the pair of opposing wires and/or contacts 35, 36 and electrically couples the opposing pair of wires and/or contacts 35, 36 via the at least partially conductive contactor 33.

In this implementation, for example, the first magnet component 32 is disposed within an opening 38 of the switch housing/body 34. The first magnet component 32 and the at least partially conductive contactor 33 are moveable within the opening 18 of the housing 14 such that in a first ON state, the conductor 33 electrically couples the pair of opposing wires and/or contacts 35, 36 of the switch 30. The first ON state of the switch 30 comprises a normal or default state in which the first magnet component 32 and the contactor 33 are magnetically drawn to a material of the pair of opposing wires and/or contacts 35, 36. In a second OFF state of the switch 30, a second component 40 of the switch 30, such as but not limited to a second magnet, paramagnetic or metal (e.g., ferrous metal) component, may also be magnetically drawn to the first magnet component 32 disposed within the housing 34. In this implementation, in the absence of the second component 40 being disposed adjacent to the housing 34, the first magnet component 32 disposed within the housing 34 is magnetically drawn to the pair of opposing wires and/or contacts 35, 36 and closes the switch 30 in a first ON state. When the second component 40 is disposed adjacent to the housing, such as shown in FIG. 4, however, the magnetic attraction between the first magnet component 32 disposed within the opening 38 of the housing 34 to the pair of opposing wires and/or contacts 35, 36 is overcome by a magnetic attraction between the first magnet component 32 disposed within the housing 34 and the second component 40 disposed adjacent to the housing 34. In this manner, the first magnet component 32 and the contactor 33 are drawn toward the second component 40 and away from the pair of opposing wires and/or contacts 35, 36 and opens the contacts of the switch 30 resulting in the second OFF state of the switch 30.

In the particular implementation shown in FIGS. 3 and 4, for example, the second component 40 is coupled to the switch housing 34, such as via a strap, lead, band or other coupling device 42. In this manner, the second component 40 may be moved to or from the position adjacent to the housing (shown in FIGS. 3 and 4) to transition the switch between the first closed ON state and the second open OFF state while still being physically coupled to the switch housing so that the second component is not lost or misplaced. In one particular implementation, for example, the switch 30 may comprise a clasp for a wearable item, such as a jewelry clasp for a wristband that may be worn by a person. In this manner, as the item is worn by the person, the clasp is engaged and held in place by a magnetic attraction between the first magnet component 32 and the second component 40 such that the switch is maintained in a second open OFF state and current from a battery coupled to the switch is prevented from flowing through the switch into an application circuit. However, when the second component 40 is physically moved away from the housing 44 (such as shown in FIG. 3), the magnetic attraction between the first magnet component 32 and the pair of opposing wires and/or contacts 35,36 draws the first magnet component 32 within the opening of the housing 34 to a position adjacent to the pair of opposing wires and/or contacts 35, 36 and electrically couples the pair of opposing wires and/or contacts 35, 36 and transitions the switch to a first closed ON state. In the first closed ON state, the switch 30 allows current to flow from a power source (e.g., a battery) coupled to the switch 30 to an application circuit, such as shown in FIGS. 7-9, via switch terminals 44, 46 and activates the application circuit.

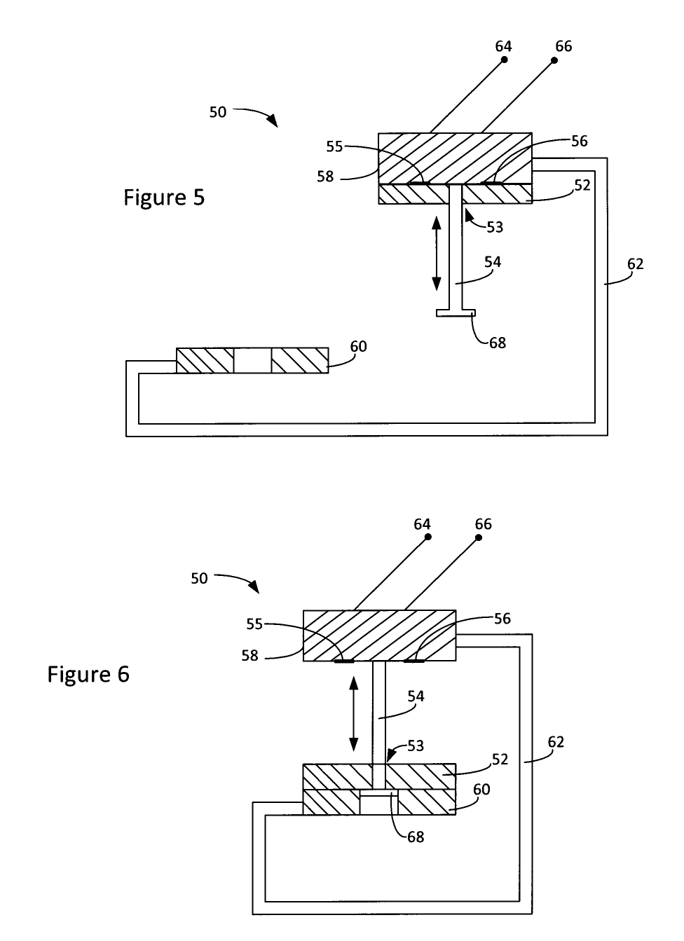

FIGS. 5 and 6 show a schematic partial cross section view of yet another example implementation of a magnetic deadman switch 50. FIG. 5 shows the example magnetic deadman switch 50 in a first closed ON state, and FIG. 6 shows the example magnetic deadman switch 50 in a second open OFF state. In this implementation, the first magnet component 52 comprises a magnet that is adapted to move and to electrically couple a pair of opposing wires and/or contacts 56 of the switch 50 to close the switch in a first ON state. The first magnet component 52, for example, may be attached to an at least partially conductive contactor that is adapted to electrically couple the pair of opposing wires and/or contacts 55, 56 when a magnetic attraction between the first magnet component 52 and the pair of opposing wires and/or contacts 35, 36 draws the first magnet component 52 and the at least partially conductive contactor adjacent to the pair of opposing wires and/or contacts 54, 56 and electrically couples the opposing pair of wires and/or contacts 55, 56 via the at least partially conductive contactor 56. The first magnet component 52 may also at least partially comprise a conductive material (such as a conductive coating, film or other part of the first magnet component) that is adapted to electrically couple the opposing pair of wires and/or contacts 55, 56.

In this implementation, for example, the first magnet component 52 comprises an opening 53 (e.g., an inner opening of an annular, ring, disk, polygon or other shaped first magnet component). The first magnet component 52 is disposed along a post 54 or other support along which the first magnet component is adapted to move generally along a length of the post as shown in FIGS. 5 and 6. The opening 53 of the first magnet component 52 is disposed about the post 54 such that the first magnet component is adapted to slide or otherwise move along the length of the post 54 between a first position and a second position. In the particular implementation shown in FIGS. 5 and 6, for example, the post 54 comprises an end stop 68 component adapted to keep the first magnet component on the post and prevent the first magnet component from falling off the switch 50. The first magnet component 52 is moveable along the post 54 such that in a first ON state, the first magnet component 52 electrically couples the pair of opposing wires and/or contacts 55, 56 of the switch 50. The first ON state of the switch 50 comprises a normal or default state in which the first magnet component 52 is magnetically drawn to a material of a pair of opposing wires and/or contacts 55, 56. In a second OFF state of the switch 50, a second component 60 of the switch 50, such as but not limited to a second magnet, paramagnetic or metal (e.g., ferrous metal) component, may also be magnetically drawn to the first magnet component 52 disposed on the post 54. In this implementation, in the absence of the second component 60 being disposed adjacent to the post 54, the first magnet component 52 disposed on the post 54 is magnetically drawn to the pair of opposing wires and/or contacts 55, 56 and closes the switch 50 in a first ON state. When the second component 60 is disposed adjacent to the housing, such as shown in FIG. 6, however, the magnetic attraction between the first magnet component 52 disposed on the post 54 and the pair of opposing wires and/or contacts 55, 56 is overcome by a magnetic attraction between the first magnet component 52 disposed on the post 54 and the second component 60 disposed adjacent to an end of the post 54. In this manner, the first magnet component 52 is drawn toward the second component 60 and away from the pair of opposing wires and/or contacts 55, 56 and opens the contacts of the switch 50 resulting in the second OFF state of the switch 50.

In the particular implementation shown in FIGS. 5 and 6, for example, the second component 60 is coupled to a switch housing 58, such as via a strap, lead, band or other coupling device 62. In this manner, the second component 60 may be moved to or from the position adjacent to the end of the post 54 (shown in FIG. 6) to transition the switch between the first closed ON state and the second open OFF state while still being physically coupled to the switch housing so that the second component 60 is not lost or misplaced. In one particular implementation, for example, the switch 50 may comprise a clasp for a wearable item, such as a jewelry clasp for a wristband that may be worn by a person. In this manner, as the item is worn by the person, the clasp is engaged and held in place by a magnetic attraction between the first magnet component 52 and the second component 60 such that the switch is maintained in a second open OFF state and current from a battery coupled to the switch is prevented from flowing through the switch into an application circuit. However, when the second component 60 is physically moved away from the post 54 (such as shown in FIG. 5), the magnetic attraction between the first magnet component 52 and the pair of opposing wires and/or contacts 55,56 draws the first magnet component 52 within the opening of the housing 54 to a position adjacent to the pair of opposing wires and/or contacts 55, 56 and electrically couples the pair of opposing wires and/or contacts 55, 56 and transitions the switch to a first closed ON state. In the first closed ON state, the switch 50 allows current to flow from a power source (e.g., a battery) coupled to the switch 50 to an application circuit, such as shown in FIGS. 7-9, via switch terminals 64, 66 and activates the application circuit.

FIG. 7 shows a schematic block diagram of an example circuit 150 including a magnetic deadman switch 152, such as the switches shown in FIGS. 1-4. In this particular implementation, the circuit 150 includes a voltage source 154, such as but not limited to a battery or capacitor. The magnetic deadman switch comprises a first terminal 156 coupled to the voltage source 154 and a second terminal 158 coupled to an application circuit 160 that is activated when the deadman switch is in a first closed ON state allowing current to flow from the voltage source 154 to the application circuit 160. When the deadman switch 152 is in a second open OFF state, however, the deadman switch 52 prevents current from flowing to the application circuit 160 and prevents the voltage source 154 from discharging.

FIG. 8 shows another schematic block diagram of one particular example circuit 170 including a magnetic deadman switch 172 adapted to control illumination of a light emitting diode LED application circuit 180. In this implementation, the circuit 170 includes a voltage source Vₛ 174, such as but not limited to a battery or capacitor. The voltage source Vₛ 174 is electrically coupled to the application circuit 180 via the switch 172. In this particular implementation, the application circuit 180 includes a light emitting diode 182 and a resistor R 184. When the switch 172 is in a first ON state, current supplied by the voltage source 174 through the light emitting diode 182 and the resistor R 184 of the application circuit 180, illuminating the light emitting diode 182 when the voltage drop across the LED 182 is greater than a forward voltage drop for the LED 182. The resistor R, in various implementations, is used to limit current to prevent damage to the light emitting diode LED 182.

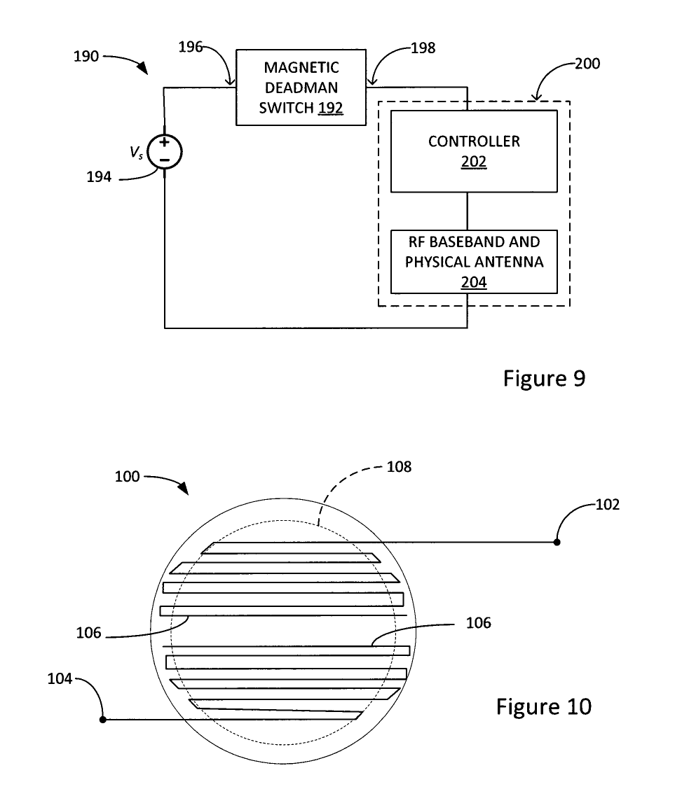

FIG. 9 shows yet another schematic block diagram of one particular example circuit 190 including a magnetic deadman switch 192 adapted to control a wireless transmitter application circuit 200. In this implementation, the circuit 190 includes a voltage source Vₛ 194, such as but not limited to a battery or capacitor. The voltage source Vₛ 194 is electrically coupled to the application circuit 200 via the switch 192. In this particular implementation, the application circuit 200 includes a controller 202 (e.g., a microcontroller), and a transmitter 204 (e.g., an RF baseband and physical antenna). When the switch 192 is in a first ON state, current supplied by the voltage source 94 through magnetic deadman switch 192 activates the controller 202 of the application circuit 200. The controller 202 prepares and wirelessly transmits a signal via the transmitter and antenna 204. In one example, the wireless transmitter circuit 190 may generate an alarm signal when the switch is activated to a first closed ON state.

Where the switch 192 comprises a clasp of a wearable item such as a wristband, for example, a person may activate the switch 192 of the circuit 190 by pulling the wristband from the wearer's arm to generate an emergency response alarm signal that may be transmitted to a monitoring system, automatically dial a telephone (e.g. a cellular mobile telephone, landline telephone, voice over internet protocol telephone), generate an alarm signal for transmission by an alarm system or other action. By pulling a component of the switch from the clasp, the magnet inside the switch is magnetically drawn to a pair of opposing wires and/or contacts to close the switch into a first closed ON state and activate a wireless transmitter activation circuit such as shown in FIG. 9.

The circuits 170, 190 shown in FIGS. 8 and 9 merely show two possible examples of application circuits that may be coupled to a voltage source via a magnetic deadman switch. Based on this disclosure, one of ordinary skill in the art could couple any number of possible application circuits to a voltage source, such as but not limited to a battery or capacitor, via a magnetic deadman switch such as described herein.

The application circuits, for example, may include an anti-theft device (e.g., secured with a cable or wire, such as a stronger magnet with sufficient lift force so that it would be hard to remove, but still remain the weakest part of a connection such as where the remainder of the connection is a steel braid cable). Similarly an application circuit could be used for home intrusion/security systems or to show something has been tampered with or opened (e.g., a building intrusion/security system, a liquor cabinet opened during the day when the parents are out. In these implementations, for example, the magnetic deadman switch would activate an application circuit to send a signal to a base-station that would determine what, if any, action to take in response to the signal. In another implementation, the application circuit may be used as a tracking device/bread crumb, the equivalent of a “please rescue me now” or dig here to find what I buried. This could work with either short range electronic signaling, or possibly have a GPS/cell phone for much longer range. Similarly, such as the example circuit shown in FIG. 6, the circuit may provide an emergency light, such as for scuba divers, cavers, rescuers or military divers. The application circuit may also provide an actuator or fuse circuit. Again, these are merely example application circuits and other circuits and response systems are contemplated.

FIG. 10 shows an example implementation of a housing 100 that may be used with any of the magnetic deadman switches described herein. In the particular implementation shown in FIG. 10, for example, the housing 100 includes a pair of terminals 102, 104 for a magnetic deadman switch. The housing further includes a pair of opposing wires 106 that are disposed on a surface of the housing (e.g., within an opening of a housing such as shown in FIG. 1-4 or adjacent to a surface of the housing near a post as shown in FIGS. 5 and 6). The opposing wires 106 are disposed such that ends of the opposing wires 106 are spaced apart and of opposing wires 106 are not electrically coupled to each other. However, when the first magnet component 108 is magnetically attracted to the pair of opposing wires 106 (in the absence of a second component described with reference to FIGS. 1-6), the first magnet component electrically couples the pair of opposing wires 106 and providing a conductive path between the pair of opposing wires as described above with respect to FIGS. 1-6.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A magnetic deadman switch comprising:
a housing;
a pair of electrical connectors coupled to the housing,
a magnet component adapted to move between a first closed position and a second open position,
wherein the magnet component is adapted to be magnetically drawn toward the pair of electrical connectors and electrically couple the pair of connectors in the first closed position, and the magnet component is adapted to be magnetically drawn away from the pair of electrical connectors and electrically open the pair of electrical connectors in the second open position.

2. The magnetic deadman switch of claim 1 wherein the housing comprises an opening and the magnet component is disposed within the opening of the housing.

3. The magnetic deadman switch of claim 1 wherein the housing comprises a post and the magnet component is disposed on the post.

4. The magnetic deadman switch of claim 1 wherein the magnet component comprises a conductive layer adapted to electrically couple the pair of connectors in the first closed position.

5. The magnetic deadman switch of claim 1 wherein the magnet component comprises a magnet component disposed adjacent to a conductive component, the conductive component adapted to electrically couple the pair of connectors in the first closed position.

6. The magnetic deadman switch of claim 1 wherein a second component is adapted to be disposed adjacent to at least one of an exterior of a housing and an end of a post to magnetically draw the magnet component away from the pair of electrical terminals.

7. The magnetic deadman switch of claim 6 wherein the second component comprises at least one of the group comprising: a second magnet component, a paramagnetic component, a metal component and a ferromagnetic component.

8. The magnetic deadman switch of claim 6 wherein the magnet component and the second component comprise neodymium magnets.

9. The magnetic deadman switch of claim 6 wherein the second component is mechanically coupled to the housing.

10. The magnetic deadman switch of claim 9 wherein the second component is mechanically coupled to the housing via at least one of the group comprising: a lead, a band, a cable, a chain, a strip and a ring.

11. The magnetic deadman switch of claim 9 wherein the switch comprises a clasp of a wearable item.

12. The magnetic deadman switch of claim 1 wherein, in the second open position, a second component is disposed adjacent to an exterior of the housing of the switch wherein a magnetic attraction between the magnet component and the second component overcomes a magnetic attraction between the magnet component and the pair of electrical connectors and magnetically draws the magnet component away from the pair of electrical connectors within the opening of the housing toward the second component.

14. The magnetic deadman switch of claim 1 wherein the pair of electrical connectors comprises a pair of conductive wires coupled to the housing.

15. The magnetic deadman switch of claim 1 wherein the pair of electrical connectors comprises a pair of contacts coupled to the housing.

16. A circuit comprising:
a voltage source;
a magnetic deadman switch comprising:
a housing;
a pair of electrical connectors coupled to the housing,
a magnet component adapted to move between a first closed position and a second open position,
wherein the magnet component is adapted to be magnetically drawn toward the pair of electrical connectors and electrically couple the pair of connectors in the first closed position, and the magnet component is adapted to be magnetically drawn away from the pair of electrical connectors and electrically open the pair of electrical connectors in the second open position,
wherein a first connector of the pair of electrical connectors is electrically coupled to the voltage source; and
an application circuit electrically coupled to a second connector of the pair of electrical connectors,
wherein the application circuit is electrically coupled to the voltage source via the first closed position of the magnetic deadman switch.

16. The circuit of claim 15 wherein the application circuit is electrically decoupled from the voltage source via the second open position of the magnetic deadman switch.

17. The circuit of claim 15 wherein the application circuit comprises at least one of the group comprising a light circuit, an emergency light circuit, a light emitting diode (LED) circuit, a transmitter circuit, a wireless transmitter circuit, a tracking circuit, a global positioning system (GPS) based location circuit, a global positioning system (GPS) based tracking circuit, an alarm circuit, an intrusion detection circuit, an intrusion alarm circuit, a tamper detection circuit, a tamper alarm circuit, an actuator circuit, a fuse circuit, a theft detection circuit and a theft detection alarm circuit.

18. A method of transitioning a switch from a first closed ON state to a second open OFF state, the method comprising:
providing a magnetic deadman switch comprising:
a housing;
a pair of electrical connectors coupled to the housing,
a magnet component adapted to move between a first closed position and a second open position,
wherein the magnet component is adapted to be magnetically drawn toward the pair of electrical connectors and electrically couple the pair of connectors in the first closed position, and the magnet component is adapted to be magnetically drawn away from the pair of electrical connectors and electrically open the pair of electrical connectors in the second open position;
positioning a second component opposed from the pair of electrical connectors; and
magnetically drawing the magnet component away from the pair of electrical connectors.

19. The method of claim 18 wherein the second component comprises at least one of the group comprising: a second magnet component, a paramagnetic component, a metal component, a ferromagnetic component and a neodymium magnet.

20. The method of claim 18 wherein the magnet component comprises at least one of a conductive layer adapted to electrically couple the pair of connectors in the first closed position and a magnet component disposed adjacent to a conductive component, the conductive component adapted to electrically couple the pair of connectors in the first closed position
